(19) United States
(12) Patent Application Publication
(10) Pub. No.: US 2025/0316884 A1
(43) Pub. Date: Oct. 9, 2025

(54) ELECTRONIC DEVICE AND NEAR FIELD COMMUNICATION ANTENNA THEREOF

(71) Applicant: PEGATRON CORPORATION, TAIPEI CITY (TW)

(72) Inventors: Chih-Wei LIAO, TAIPEI CITY (TW); Huan-Chia CHANG, TAIPEI CITY (TW); Chien-Yi WU, TAIPEI CITY (TW); Chao-Hsu WU, TAIPEI CITY (TW); Chen-Kuang WANG, TAIPEI CITY (TW); Cheng-Hsiung WU, TAIPEI CITY (TW); Shih-Keng HUANG, TAIPEI CITY (TW); Chia-Hung CHEN, TAIPEI CITY (TW); Hau-Yuen TAN, TAIPEI CITY (TW)

(21) Appl. No.: 19/082,331

(22) Filed: Mar. 18, 2025

(30) Foreign Application Priority Data
Apr. 3, 2024 (TW) 113112837

(51) Int. Cl. H01Q 1/22; H01Q 7/00

(52) U.S. Cl. CPC H01Q 1/22; H01Q 7/00

(57) ABSTRACT

An electronic device includes a metal back cover, a wiring board, a near field communication antenna, and a display front cover. The metal back cover includes a shell, a groove, and an accommodating groove. The groove and the accommodating groove are formed at the shell, respectively. The near field communication antenna is fixed in the groove. The near field communication antenna linearly extends in a long axis direction of the groove and is electrically connected with the wiring board. The display front cover covers the shell, the accommodating groove, the groove, and the near field communication antenna, and is electrically connected with the wiring board.

### RELATED APPLICATIONS

This application claims priority to Taiwanese Application Serial Number 113112837, filed Apr. 3, 2024, which is herein incorporated by reference.

### BACKGROUND

### Field of Invention

The present disclosure relates to an electronic device and, more particularly, to an electronic device with a near field communication antenna inside.

### Description of Related Art

With the development of mobile communication technology, near field communication (NFC) modules (e.g. proximity readers) have been integrated into mobile apparatuses (e.g. laptops, mobile phones, or multimedia players) for contactless point-to-point data transmission between electronic devices.

However, most mobile apparatuses on the market are designed with metal enclosures and narrow-border displays, and the structure of traditional NFC sensor modules on the market is complex and large, so the design of integrating NFC sensor modules into the mobile apparatuses may face the limitation from the environmental spaces of the metal enclosures and the narrow-border displays, resulting in increased design difficulty and weakened card reading performance.

### SUMMARY

One objective of the present disclosure is to provide an electronic device and a near field communication antenna thereof to solve the difficulties mentioned in the related art.

The present disclosure provides an electronic device. The electronic device includes a metal back cover, a wiring board, a near field communication antenna, and a display front cover. The metal back cover includes a shell, a groove, and an accommodating groove, and the groove and the accommodating groove are formed at the shell, respectively. The wiring board is fixed in the accommodating groove. The near field communication antenna is fixed in the groove. The near field communication antenna extends linearly in a long axis direction of the groove and is electrically connected with the wiring board. The display front cover covers the shell, the accommodating groove, the groove, and the near field communication antenna, and is electrically connected with the wiring board.

According to one or more embodiments of the present disclosure, in the electronic device, the metal back cover may further include a notch. The notch may communicate with the groove and the accommodating groove. The near field communication antenna may include a flexible circuit board, an antenna pattern group, and a magnetic conductive layer. The flexible circuit board may include a first sheet, a second sheet, and a third sheet. The first sheet may be positioned in the groove and the notch and may extend linearly in a long axis direction. The second sheet may be positioned in the accommodating groove and connected with the wiring board. The second sheet may be positioned at a different horizontal height from the first sheet. The third sheet may be connected with the first sheet and the second sheet. The antenna pattern group may be formed on the first sheet. The magnetic conductive layer may be positioned on the first sheet of the flexible circuit board.

According to one or more embodiments of the present disclosure, in the electronic device, the near field communication antenna may further include a supporting plate. The supporting plate may support the first sheet and may be horizontally placed at a bottom of the groove and a bottom of the notch, and the magnetic conductive layer may be clamped between the first sheet and the supporting plate.

According to one or more embodiments of the present disclosure, in the electronic device, the groove may include a groove end and a groove opening which are opposite to each other. One end of the first sheet may extend towards the groove end of the groove, while the other end of the first sheet may extend to the groove opening.

According to one or more embodiments of the present disclosure, in the electronic device, the antenna pattern group may include a first winding pattern and a second winding pattern. The first winding pattern may be formed on an upper surface of the first sheet. The second winding pattern may be formed on a lower surface of the first sheet opposite to the upper surface and may be misaligned with the first winding pattern in a vertical direction.

According to one or more embodiments of the present disclosure, in the electronic device, the electronic device may further include an operation interface group. The operation interface group may be positioned in the shell. The operation interface group may overlap the near field communication antenna in the vertical direction and may be electrically connected with the wiring board. A concave groove may be further formed in the shell. The concave groove may be in communication with the groove and accommodates the operation interface group, and it may be covered by the near field communication antenna.

According to one or more embodiments of the present disclosure, the electronic device may further include at least one magnetic body. The magnetic body may be positioned at the bottom of the concave groove and may overlap the antenna pattern group on the first sheet in the vertical direction, and there may be a spacing gap defined between the magnetic body and the first sheet.

According to one or more embodiments of the present disclosure, the length-width ratio of one part of the near field communication antenna may be 4-6.

An embodiment of the present disclosure provides an electronic device. The electronic device includes a metal back cover, a wiring board, a near field communication antenna, an operation interface group, and a display front cover. The metal back cover includes a shell and an element placing area. A central area and a frame area are defined on a top surface of the shell. The frame area surrounds the central area, and the element placing area is positioned in the frame area. The wiring board is fixed in the central area of the shell. The operation interface group is positioned in the element placing area and electrically connected with the wiring board. The near field communication antenna is long and narrow and is positioned in the element placing area. The near field communication antenna is overlapped on the operation interface group in a vertical direction and is electrically connected with the wiring board. The display front cover covers the top surface of the shell and the near field communication antenna and is electrically connected with the wiring board.

According to one or more embodiments of the present disclosure, in the electronic device, the metal back cover may further include a groove, an accommodating groove, and a notch. The accommodating groove may be formed in the central area of the shell and accommodate the wiring board. The groove may be positioned in the element placing area, and the notch may communicate with the groove and the accommodating groove. The near field communication antenna may include a flexible circuit board, an antenna pattern group, and a magnetic conductive layer. The flexible circuit board may include a first sheet, a second sheet, and a third sheet. The first sheet may be positioned in the groove and the notch, and linearly extend in the long axis direction of the groove. The second sheet may be positioned in the accommodating groove and connected with the wiring board. The second sheet may be positioned at a different horizontal height from the first sheet. The third sheet may be connected with the first sheet and the second sheet. The antenna pattern group may be formed on the first sheet. The magnetic conductive layer may be positioned on the first sheet of the flexible circuit board.

According to one or more embodiments of the present disclosure, in the electronic device, the near field communication antenna may further include a supporting plate. The supporting plate may support the first sheet and may be horizontally placed at a bottom of the groove and a bottom of the notch. The magnetic conductive layer may be clamped between the first sheet and the supporting plate.

According to one or more embodiments of the present disclosure, in the electronic device, the groove may include a groove end and a groove opening which are opposite to each other. One end of the first sheet may extend towards the groove end of the groove, while the other end of the first sheet may extend to the groove opening.

According to one or more embodiments of the present disclosure, in the electronic device, the antenna pattern group may include a first winding pattern and a second winding pattern. The first winding pattern may be formed on an upper surface of the first sheet. The second winding pattern may be formed on a lower surface of the first sheet opposite to the upper surface and may be misaligned with the first winding pattern in the vertical direction.

According to one or more embodiments of the present disclosure, in the electronic device, the concave groove may be further formed in the shell. The concave groove may be in communication with the groove and accommodate the operation interface group and may be covered by the near field communication antenna. At least one magnetic body may be further positioned at the bottom of the concave groove and may overlap the antenna pattern group on the first sheet in the vertical direction. There may be a spacing gap defined between the magnetic body and the first sheet.

According to one or more embodiments of the present disclosure, in the electronic device, the length-width ratio of one part of the near field communication antenna may be 4-6.

An embodiment of the present disclosure provides a near field communication antenna of an electronic device, and the near field communication antenna of an electronic device includes a flexible circuit board, a magnetic conductive layer, a supporting plate, and an antenna pattern group. The flexible circuit board is in a three-dimensional asymmetric type, and includes a first sheet, a second sheet, and a third sheet. The first sheet extends linearly in an extending direction. The second sheet and the first sheet are at different heights in a vertical direction. The third sheet is connected with the first sheet and the second sheet. The magnetic conductive layer is clamped between the first sheet and the supporting plate. The antenna pattern group is formed on the first sheet.

According to one or more embodiments of the present disclosure, in the near field communication antenna, the antenna pattern group may include a first winding pattern and a second winding pattern. The first winding pattern may be formed on an upper surface of the first sheet. The second winding pattern may be formed on a lower surface of the first sheet opposite to the upper surface and may be misaligned with the first winding pattern in the vertical direction.

According to one or more embodiments of the present disclosure, in the near field communication antenna, the length-width ratio of the first sheet of the near field communication antenna may be 4-6.

Thus, through the above architecture, in the present disclosure, the near field communication antenna can be effectively integrated into the electronic device under the limitation of the environment space of the metal enclosure and the like, and therefore the limitation under the requirements of a full metal enclosure, the narrow-border display, front sensing with more convenient operation and a high communication distance is broken through.

The above is only used for describing the problem to be solved, the technical means to solve the problem, and the effect thereof and the like in the present disclosure, and the specific details of the present disclosure will be described in detail in the following implementations and related figures.

### BRIEF DESCRIPTION OF THE DRAWINGS

FIG. 1 is a three-dimensional view of an electronic device according to an embodiment of the present disclosure.

FIG. 2 is an exploded view of the electronic device in FIG. 1.

FIG. 3 is a partial three-dimensional view of a main unit of the device in FIG. 1.

FIG. 4 is a cross-sectional view taken along a line AA in FIG. 1.

FIG. 5 is a cross-sectional view taken along a line BB in FIG. 2.

FIG. 6 is a top view of the first sheet of the flexible circuit board in FIG. 2.

### DETAILED DESCRIPTION

A plurality of embodiments of the present disclosure will be described below with reference to diagrams, and for the sake of clarity, many practical details will be described in the following description. However, it is to be understood that these practical details are not to be used for limiting the present disclosure. That is, in each embodiment of the present disclosure, these practical details are not necessary. In addition, for the sake of simplifying the diagrams, some of the conventional and commonly used structures and elements will be described in a simple schematic way in the diagrams.

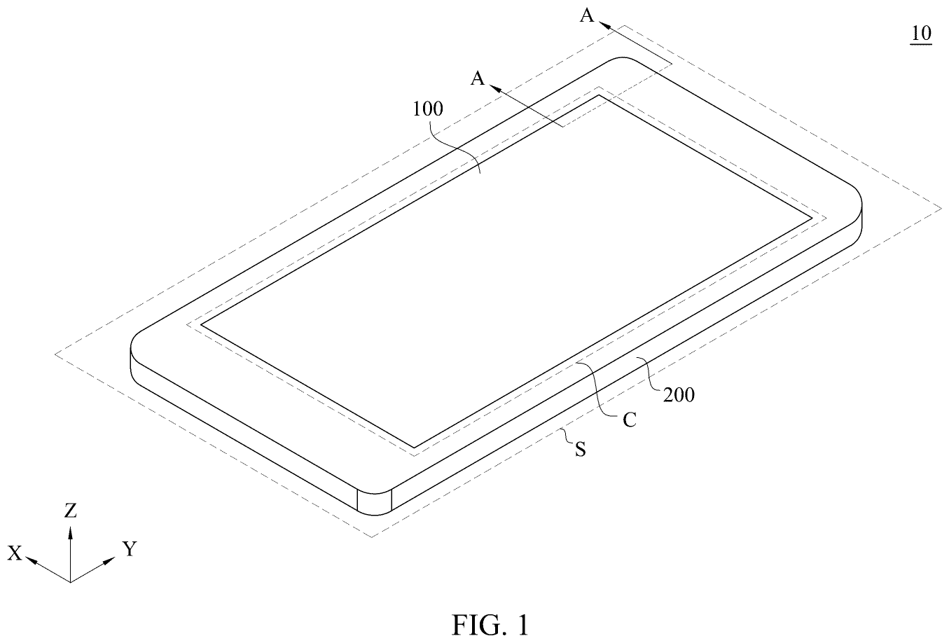

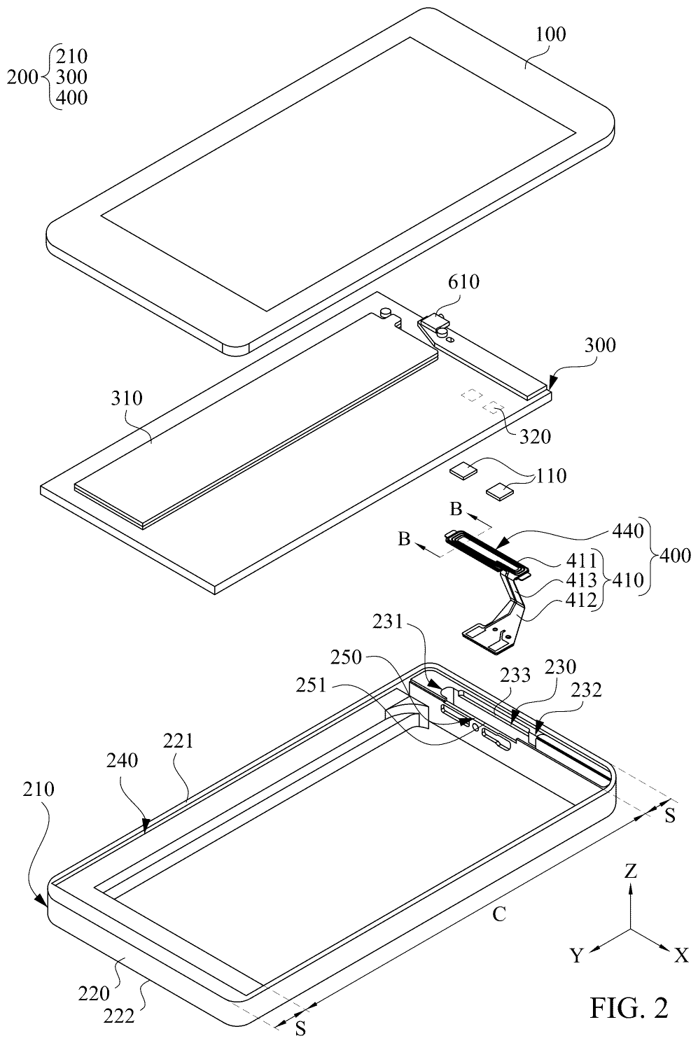

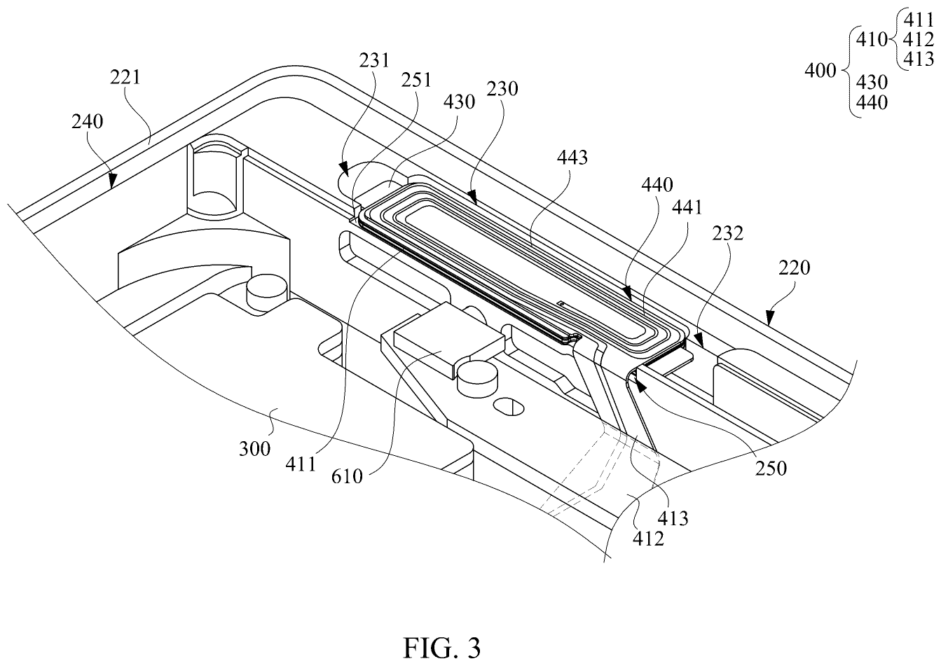

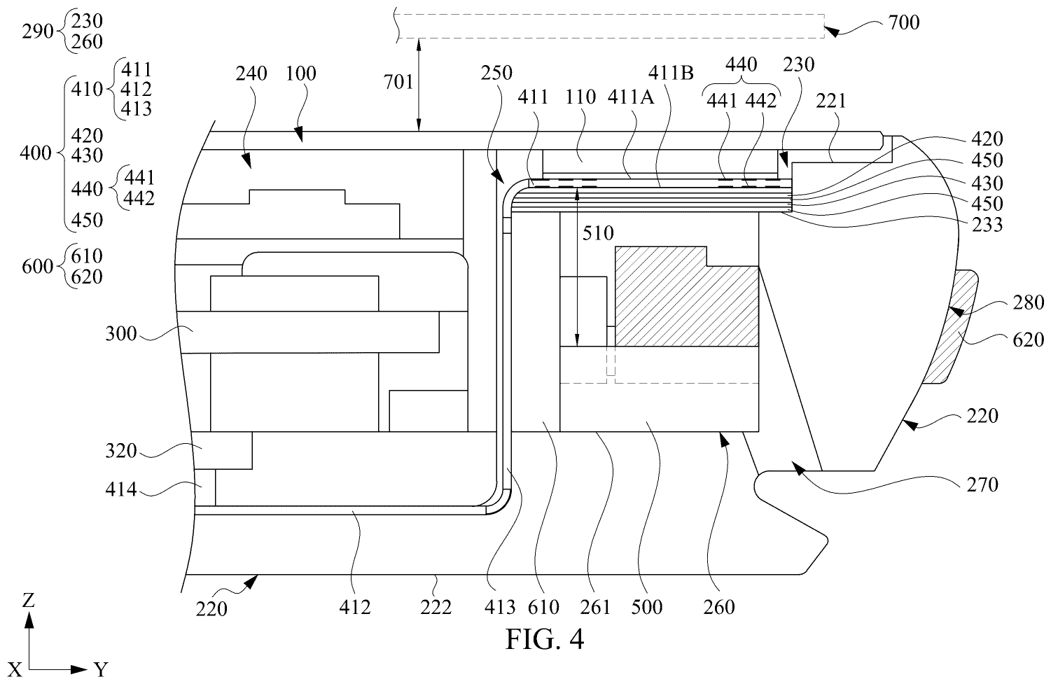

FIG. 1 is a three-dimensional view of an electronic device 10 according to an embodiment of the present disclosure. FIG. 2 is an exploded view of the electronic device 10 in FIG. 1. FIG. 3 is a partial three-dimensional view of a main unit 200 of the device in FIG. 1. FIG. 4 is a cross-sectional view taken along a line AA in FIG. 1.

In this embodiment, as shown in FIG. 1 and FIG. 2, the electronic device 10 includes a display front cover 100 and a main unit 200. The display front cover 100 can be made of non-metal materials such as glass or plastic. The main unit 200 includes a metal back cover 210, a wiring board 300, and a near field communication (NFC) antenna 400. The metal back cover 210 includes a shell 220, a groove 230, an accommodating groove 240, and a notch 250. The groove 230 and the accommodating groove 240 are respectively concavely formed at the same side of the shell 220. The groove 230 linearly extends in an X-axis direction, and the notch 250 is formed at the shell 220 and communicates with the groove 230 and the accommodating groove 240. The wiring board 300 is fixed in the accommodating groove 240 and is electrically connected with the display front cover 100 and the near field communication antenna 400. One part of the near field communication antenna 400 is positioned in the groove 230, while the other part of the near field communication antenna extends into the accommodating groove 240 (in FIG. 3 and FIG. 4) through the notch 250. The part of the near field communication antenna 400 is in a long axis shape and has a large antenna axial ratio, and it linearly extends in the long axis direction (such as X axis) of the groove 230. The display front cover 100 can cover the shell 220, the accommodating groove 240, the groove 230, the near field communication antenna 400 positioned in the groove 230, and the wiring board 300 positioned in the accommodating groove 240, so that the wiring board 300 and the near field communication antenna 400 are covered between the metal back cover 210 and the display front cover 100.

More specifically, in FIG. 1 and FIG. 2, the shell 220 of the metal back cover 210 is provided with a top surface 221 and a back surface 222 which are opposite to each other. A central area C and a frame area S are defined on the top surface 221 of the shell 220. The frame area S completely surrounds the central area C. In this embodiment, the central area C and an effective display area of the display front cover 100 are roughly overlapped in position and roughly equal in range. The frame area S and a black matrix (BM) of the display front cover 100 are roughly overlapped in position and roughly equal in range. The accommodating groove 240 is positioned in the central area C and linearly extends in the long axis direction (such as Y axis) of the electronic device 10. The groove 230 is positioned in the frame area S, and linearly extends in the X axis direction. The notch 250 is concavely formed in an adjacent position of the central area C and the frame area S, and the length of the notch 250 is smaller than that of the groove 230.

In the FIG. 2 and FIG. 3, the wiring board 300 includes an RLC impedance matching circuit 310 and multiple elastic pieces 320. The elastic pieces 320 are positioned on the wiring board 300 and are electrically connected with the RLC impedance matching circuit 310. In this embodiment, the wiring board 300 may be a mainboard of the electronic device 10, but the present disclosure is not limited to this.

The near field communication antenna 400 includes a flexible circuit board 410 and an antenna pattern group 440. The flexible circuit board 410 is in a three-dimensional asymmetric type and has a Z-shaped section. The flexible circuit board 410 includes a first sheet 411, a second sheet 412, and a third sheet 413. The first sheet 411 is positioned in the groove 230 and the notch 250. The second sheet 412 is positioned in the accommodating groove 240 and is positioned at a different horizontal height from the first sheet 411 and connected with the wiring board 300 (FIG. 4). The second sheet 412 is arranged on the wiring board 300 in an overlapped mode and electrically connected with the elastic pieces 320 of the wiring board 300 in a conductive mode through an electrode plate 414, thereby reducing the influence of whole unit assembly on the waviness. The third sheet 413 is connected with the first sheet 411 and the second sheet 412. The antenna pattern group 440 is formed on the first sheet 411 and electrically connected with the wiring board 300 through the second sheet 412 and the third sheet 413 (FIG. 4).

In this embodiment, in FIG. 3 and FIG. 4, the first sheet 411 is long and narrow and has the antenna axis ratio (such as the length-width ratio of 4-6), and it extends linearly in the long axis direction (such as X axis) of the groove 230. For example, but not limited to this, the length and the width of the first sheet 411 are 25.6 mm and 5.6 mm, respectively, and therefore the antenna axis ratio is 25.6:5.6. That is, the length-width ratio is 4.5 ( 25.6/5.6). The second sheet 412 extends roughly in the long axis direction (such as Y axis) of the electronic device 10. The second sheet 412 and the first sheet 411 are at different heights in the vertical direction (such as Z axis). For example, the height of the first sheet 411 is larger than that of the second sheet 412 (FIG. 4). The third sheet 413 is connected with a side edge of the first sheet 411 and a side edge of the second sheet 412. However, the present disclosure is not limited to this.

The groove 230 includes a groove end 231 and a groove opening 232 which are opposite to each other. One end of the first sheet 411 extends towards the groove end 231 of the groove 230, while the other end of the first sheet 411 extends to or extends towards the groove opening 232 to break an eddy current, and therefore a communication distance 701 of a proximity card 700 is increased, and the near field communication antenna 400 has the characteristic of miniaturization design. In addition, more specifically, for example, the length and the width of the groove 230 may be 26 mm and 6 mm, respectively, and therefore the length-width ratio of the groove 230 is 4.33 ( 26/6). For example, the groove 230 is positioned in an upper left corner of the metal back cover 210. The groove 230 is distanced by 15.1 mm from a long side edge of the shell 220 and is distanced by 3.6 mm from a short side edge of the shell 220, and the width of the groove opening 232 is 3.2 mm.

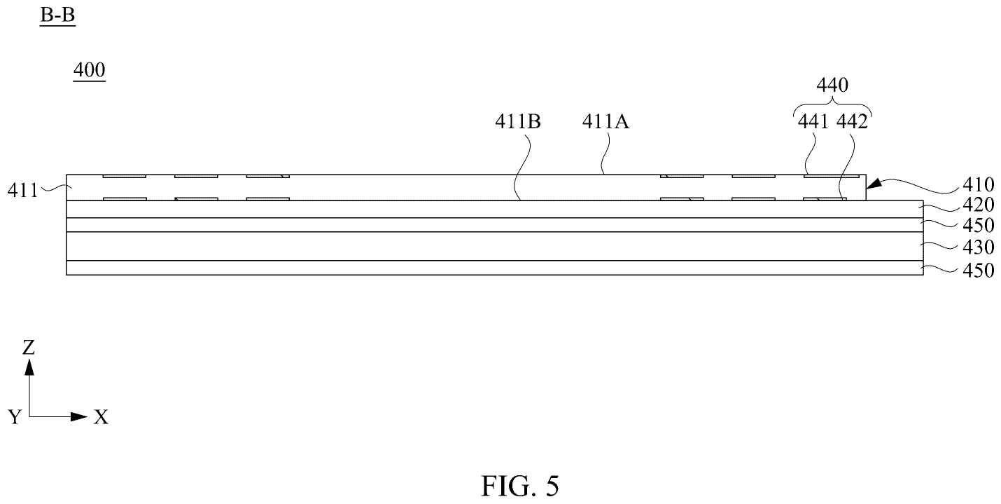

FIG. 5 is a cross-sectional view taken along a line BB in FIG. 2. In addition, in FIG. 3 and FIG. 5, the near field communication antenna 400 further includes a magnetic conductive layer 420 and a supporting plate 430. The magnetic conductive layer 420 is clamped between the first sheet 411 and the supporting plate 430. The magnetic conductive layer 420 may be a ferrite layer. The magnetic conductive layer 420 is combined with the first sheet 411 and the supporting plate 430 through an adhesive layer 450. However, the present disclosure is not limited to this. The supporting plate 430 can be horizontally placed on the groove 230 and the notch 250, and therefore the supporting plate 430 is enough to bear the magnetic conductive layer 420 and the first sheet 411. For example, the thickness of the supporting plate 430 may be 0.5 mm.

For example, an inner flange 233 is arranged in the groove 230, and an inner bottom surface 251 is arranged in the notch 250. The inner flange 233 of the groove 230 and the inner bottom surface 251 of the notch 250 are oppositely arranged on two opposite sides of the groove 230 and are at the same height in the vertical direction (such as Z axis). Accordingly, the inner flange 233 and the inner bottom surface 251 are bearing planes for bearing the magnetic conductive layer 420 and the first sheet 411, and the supporting plate 430 can be horizontally placed on the bearing planes. However, the present disclosure is not limited to this.

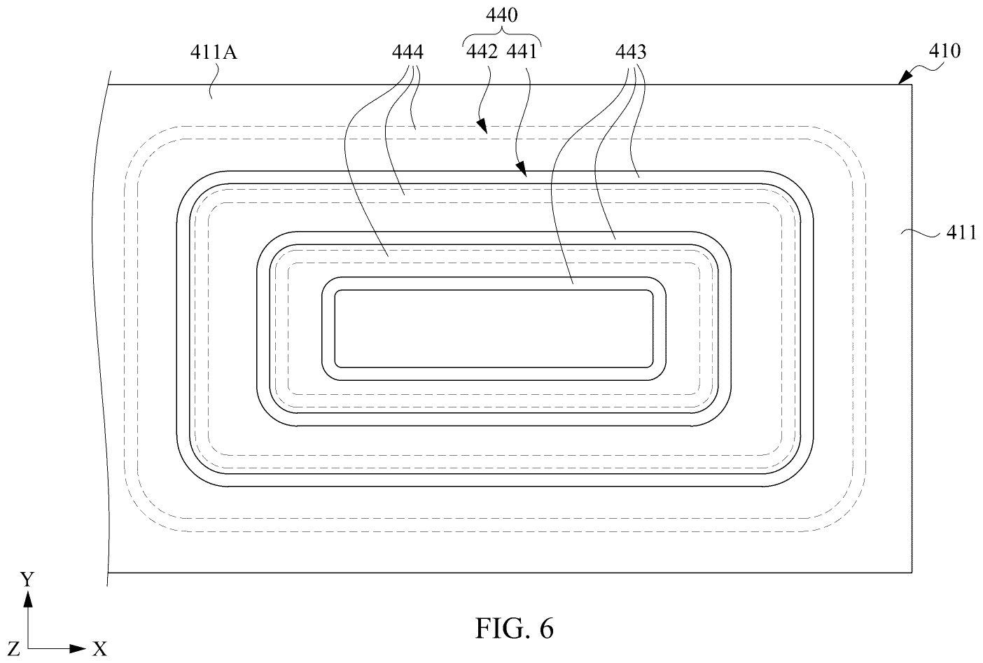

FIG. 6 is a top view of the first sheet 411 of the flexible circuit board 410 in FIG. 2. In FIG. 4 and FIG. 6, the first sheet 411 includes an upper surface 411A and a lower surface 411B which are opposite to each other, and the antenna pattern group 440 is formed on the upper surface 411A and the lower surface 411B of the first sheet 411 at the same time. More specifically, the antenna pattern group 440 includes a first winding pattern 441 and a second winding pattern 442. The first winding pattern 441 is formed on the upper surface 411A of the first sheet 411 and is provided with multiple circles (such as 3 circles) of radiators 443, and the second winding pattern 442 is formed on the lower surface 411B of the first sheet 411 and is provided with multiple circles (such as 3 circles) of radiators 444. In addition, the second winding pattern 442 and the first winding pattern 441 are misaligned with each other in the vertical direction (such as Z axis). That is, an orthographic projection surface of the first winding pattern 441 to the back surface 222 of the shell 220 and an orthographic projection surface of the second winding pattern 442 to the back surface 222 of the shell 220 are not overlapped.

Accordingly, through the antenna pattern group 440, an equivalent antenna inductance value (LA) is large enough so as to be beneficial to matching and reducing equivalent antenna resistance (RA) and thereby reducing the ohmic loss, and the antenna pattern group 440 is subjected to an avoiding wiring design, which is helpful to further narrow the length-width ratio of the near field communication antenna 400 into 5.6 ( 25.6/4.61) to cover the antenna feature of a 13.56 MHz frequency band. In addition, the design structure is simple, and the impedance matching is easy to adjust, so that the card reading distance of 13.56 MHz can be excited to reach 15 mm to meet the specification requirements of the proximity cards 700 (Type #1 to Type #5).

The electronic device 10 further includes an operation interface group (such as a key module 600). The operation interface group is positioned in the shell 220 and overlaps the antenna pattern group 440 in the vertical direction (such as Z axis). The operation interface group is electrically connected with a wiring board 300. For example, a concave groove 260 and a heat dissipation hole 270 in communication with the concave groove 260 are further formed in the shell 220. The concave groove 260 is positioned below the groove 230 and is in communication with the groove 230. The concave groove 260 can accommodate the operation interface group (such as the key module 600) and can be covered by the near field communication antenna 400.

It is to be understood that the groove 230 and the concave groove 260 are jointly called an element placing area 290. That is, the near field communication antenna 400 and the key module 600 are placed in the element placing area 290 together. The operation interface group may be the key module 600 (such as a power switch and a volume key). The key module 600 includes a trigger switch 610 and a key body 620. The trigger switch 610 is electrically connected with the wiring board 300. The key body 620 is connected with the trigger switch 610. A side edge of the shell 220 is provided with a through hole 280, and the concave groove 260 communicates the groove 230 with the through hole 280. The trigger switch 610 is positioned in the concave groove 260, and the key body 620 is positioned in the concave groove 260 and partially extends out of the through hole 280.

The near field communication antenna 400 further includes multiple magnetic bodies 500 (such as magnets). The magnetic bodies 500 are distributed at a bottom 261 of the concave groove 260 at intervals. The magnetic bodies 500 are overlapped with the antenna pattern group 440 on the first sheet 411 in the vertical direction, and a spacing gap 510 is formed between the magnetic bodies 500 and the first sheet 411. The key module 600 is positioned among the magnetic bodies 500. For example, the near field communication antenna 400 is limited by the space of the element placing area 290, so that two magnetic bodies 500 (such as 4*4*2 mm magnets) can be used for increasing the communication distance 701 of the magnetic flux of the near field communication antenna 400. In this embodiment, the communication distance 701 of at least 2 mm of the proximity card 700 relative to the near field communication antenna 400 can be increased.

In FIG. 3 and FIG. 4, the display front cover 100 further includes multiple (such as two) spacing elements 110 (such as insulating buffer bodies like foam and rubber), and the spacing elements 110 are distributed at intervals. Each spacing element 110 is directly clamped between the first sheet 411 and the display front cover 100.

Accordingly, through the above architecture, in the present disclosure, due to the limitation of the metal narrow border, the space between lines can be reduced to 0.2 mm from 2 mm of the general standard under the limit of 6 mm of the width of a very small Y axis; a three-dimensional asymmetric upper-lower double-layer winding structure is used for forming the design of 6 circles of pattern wires, and thus the equivalent antenna inductance value (LA) is large enough so as to be beneficial to matching and reducing the equivalent antenna resistance (RA) and thereby reducing the ohmic loss; and a ferrite sheet is arranged under the near field communication antenna, and the magnetic permeability ratio μr″/μr′ under 13.56 MHz is smaller than 0.1, so the field intensity can be effectively concentrated upwards, and front sensing which is more convenient for a user to operate is achieved.

Thus, through the above architecture, in the present disclosure, the near field communication antenna can be effectively integrated into the electronic device under the limitation of the environment space of the metal enclosure and the like, and therefore the limitation under the requirements of a full metal enclosure, the narrow-border display, front sensing with more convenient operation and a high communication distance is broken through.

Finally, each embodiment of the present disclosure is not used for limiting the present disclosure, and any person skilled in the art can make various changes and modifications without departing from the spirit and scope of the present disclosure, and the changes and modifications can be protected in the present disclosure. Therefore, the scope of protection of the present disclosure shall be subject to the definition of the attached claims.

What is claimed is:

1. An electronic device, comprising:
a metal back cover including a shell, a groove and an accommodating groove, wherein the groove and the accommodating groove are formed at the shell, respectively;
a wiring board fixed in the accommodating groove;
a near field communication antenna fixed in the groove, the near field communication antenna extending linearly in a long axis direction of the groove, and electrically connected with the wiring board; and
a display front cover covering the shell, the accommodating groove, the groove, and the near field communication antenna, and electrically connected with the wiring board.

2. The electronic device according to claim 1, wherein the metal back cover further comprises a notch communicating with the groove and the accommodating groove; and
the near field communication antenna comprises:
a flexible circuit board including a first sheet, a second sheet, and a third sheet, the first sheet positioned in the groove and the notch and extending linearly in the long axis direction, the second sheet positioned in the accommodating groove and connected with the wiring board, and the second sheet positioned at a different horizontal height from the first sheet, and the third sheet connected with the first sheet and the second sheet;
an antenna pattern group formed on the first sheet; and
a magnetic conductive layer positioned on the first sheet of the flexible circuit board.

3. The electronic device according to claim 2, wherein the near field communication antenna further comprises:
a supporting plate supporting the first sheet and horizontally placed at a bottom of the groove and a bottom of the notch,
wherein the magnetic conductive layer is clamped between the first sheet and the supporting plate.

4. The electronic device according to claim 2, wherein the groove comprises a groove end and a groove opening which are opposite to each other, and one end of the first sheet extends towards the groove end of the groove, while the other end of the first sheet extends to the groove opening.

5. The electronic device according to claim 2, wherein the antenna pattern group comprises:
a first winding pattern formed on an upper surface of the first sheet; and
a second winding pattern formed on a lower surface of the first sheet opposite to the upper surface and misaligned with the first winding pattern in a vertical direction.

6. The electronic device according to claim 2, further comprising:
an operation interface group positioned in the shell, the operation interface group overlapping the near field communication antenna in a vertical direction and electrically connected with the wiring board,
wherein a concave groove is further formed in the shell, and the concave groove is in communication with the groove and accommodates the operation interface group, and the concave groove is covered by the near field communication antenna.

7. The electronic device according to claim 6, further comprising:
at least one magnetic body which is positioned at a bottom of the concave groove, wherein the magnetic body overlaps the antenna pattern group on the first sheet in the vertical direction, and a spacing gap is defined between the magnetic body and the first sheet.

8. The electronic device according to claim 1, wherein a length-width ratio of one part of the near field communication antenna is 4-6.

9. An electronic device, comprising:
a metal back cover including a shell and an element placing area, wherein a central area and a frame area are defined on a top surface of the shell, the frame area surrounds the central area, and the element placing area is positioned in the frame area;
a wiring board fixed in the central area of the shell;
an operation interface group positioned in the element placing area and electrically connected with the wiring board;
a near field communication antenna which is long and narrow, positioned in the element placing area, wherein the near field communication antenna is overlapped on the operation interface group in a vertical direction and is electrically connected with the wiring board; and
a display front cover covering the top surface of the shell and the near field communication antenna and electrically connected with the wiring board.

10. The electronic device according to claim 9, wherein the metal back cover further comprises a groove, an accommodating groove and a notch, the accommodating groove is formed in the central area of the shell and accommodates the wiring board, the groove is positioned in the element placing area, and the notch communicates with the groove and the accommodating groove, and
the near field communication antenna includes:
a flexible circuit board including a first sheet, a second sheet and a third sheet, the first sheet positioned in the groove and the notch and extending linearly in a long axis direction, the second sheet positioned in the accommodating groove and connected with the wiring board, and the second sheet being positioned at a different horizontal height from the first sheet, and the third sheet connected with the first sheet and the second sheet;
an antenna pattern group formed on the first sheet; and
a magnetic conductive layer positioned on the first sheet of the flexible circuit board.

11. The electronic device according to claim 10, wherein the near field communication antenna further comprises:
a supporting plate supporting the first sheet and horizontally placed at a bottom of the groove and a bottom of the notch, wherein the magnetic conductive layer is clamped between the first sheet and the supporting plate.

12. The electronic device according to claim 10, wherein the groove comprises a groove end and a groove opening which are opposite to each other, and one end of the first sheet extends towards the groove end of the groove, while the other end of the first sheet extends to the groove opening.

13. The electronic device according to claim 10, wherein the antenna pattern group comprises:
a first winding pattern formed on an upper surface of the first sheet; and
a second winding pattern formed on a lower surface of the first sheet opposite to the upper surface and misaligned with the first winding pattern in the vertical direction.

14. The electronic device according to claim 10, wherein a concave groove is further formed in the shell, the concave groove is in communication with the groove and accommodates the operation interface group, and is covered by the near field communication antenna, and
at least one magnetic body is further positioned at a bottom of the concave groove, the magnetic body overlaps the antenna pattern group on the first sheet in the vertical direction, and a spacing gap is defined between the magnetic body and the first sheet.

15. The electronic device according to claim 9, wherein a length-width ratio of one part of the near field communication antenna is 4-6.

16. A near field communication antenna of an electronic device, comprising:
a supporting plate;
a flexible circuit board which is in a three-dimensional asymmetric type and includes a first sheet, a second sheet, and a third sheet, wherein the first sheet extends linearly in an extending direction, the second sheet and the first sheet are at different heights in a vertical direction, and the third sheet is connected with the first sheet and the second sheet;
a magnetic conductive layer clamped between the first sheet and the supporting plate; and
an antenna pattern group formed on the first sheet.

17. The near field communication antenna of the electronic device according to claim 16, wherein the antenna pattern group comprises:
a first winding pattern formed on an upper surface of the first sheet; and
a second winding pattern formed on a lower surface of the first sheet opposite to the upper surface and misaligned with the first winding pattern in the vertical direction.

18. The near field communication antenna of the electronic device according to claim 16, wherein a length-width ratio of the first sheet is 4-6.
